(19) United States
(12) Patent Application Publication
(10) Pub. No.: US 2016/0143344 A1
(43) Pub. Date: May 26, 2016

(54) Method and Device for Preserving and Restoring Crispness to Food Items

(71) Applicant: Joseph Lutgen, Costa Mesa, CA (US)

(72) Inventor: Joseph Lutgen, Costa Mesa, CA (US)

(21) Appl. No.: 14/866,685

(22) Filed: Sep. 25, 2015

Related U.S. Application Data
(60) Provisional application No. 62/071,559, filed on Sep. 26, 2014.
(60) Provisional application No. 62/232,467, filed on Sep. 25, 2015.

(51) Int. Cl. A23L 3/3427; B65D 33/16

(52) U.S. Cl. CPC A23L 3/3427; B65D 33/16; A23V 2002/00

(57) ABSTRACT

The presently disclosed devices and methods allow for preserving and restoring crispiness to snack food by placing a specific type of desiccant device in the original packaging of the food item and then closing up the package and securing the closure, even if not completely airtight. In some embodiments it may be desirable to position the desiccant away from direct contact with the food item. Prior to deployment, the individual desiccant device or pod can be activated by removing a moisture barrier strip or, alternatively, removing the device from an airtight individual package. One possible embodiment is to use magnetic material to enable the desiccant device to be held in place above the level of the product within a package by a magnetic material outside of the package.

### PRIORITY

This application claims benefit of U.S. provisional application 62/071,559 and U.S. provisional application 62/232,467 by the same inventor, filed on Sep. 26, 2014, and Sep. 25, 2015, respectively. Both applications are hereby incorporated herein by reference in their entirety.

### FIELD

This disclosure covers methods and devices performing a desiccant function.

### BACKGROUND

Food products such as potato chips, crackers, pretzels, nuts, cereal and other similar products are generally packaged in some type of plastic bag that is sealed airtight at the factory. After being purchased, the bag is opened to allow access to the food. Often the package is large enough that the food product inside is not entirely consumed in a single setting. Consumers may expect food products such as potato chips, crackers, pretzels, etc., to last a week or longer. Unless the package was evacuated of air and resealed in an airtight manner, that may not be achieved.

Previous attempts to solve the problem have limitations for various reasons. Some require storing the food in a container other than the original packaging; some clips can be ineffective at re-sealing in an airtight fashion and no amount of re-sealing will help a crisp product that has already absorbed moisture and lost its crispness.

### SUMMARY

The presently disclosed devices and methods allow for preserving and restoring crispiness to snack food by placing a specific type of desiccant device in the original packaging of the food item and then closing up the package and securing the closure, even if not completely airtight. In some embodiments it may be desirable to position the desiccant away from direct contact with the food item to allow easy retrieval after use. Prior to deployment, the individual desiccant device can be activated by removing a moisture barrier strip or, alternatively, removing the device from an airtight individual package. In the case of the apparatus seen on FIGS. 1A and 1B both a moisture proof package and a moisture barrier strip protect to desiccant from being prematurely activated. One possible embodiment is to use magnetic material to enable the desiccant device to be held in place above the level of the product within a package by a magnetic material outside of the package.

### BRIEF OVERVIEW OF THE DRAWINGS

FIG. 1A shows a schematic representation of a desiccant device with a peel off moisture barrier in a moisture-proof package;

FIG. 1B shows a sectional view of the device of 1A in a cross section along 1B-1B;

FIG. 2A shows a potato chip bag with internally located desiccant device having a backing of a magnetic material (not seen in this view) that is held in a desired location within the bag by an external, magnetic part. In this version, the magnetic part is combined with a clip;

FIG. 2B shows an enlarged view of the clip and magnetic part of FIG. 2A.

FIG. 3 is a schematic representation of a desiccant device attached to a magnetic material being held in place within a bag by an external magnet.

### DETAILED DESCRIPTION

Several of these examples presented and mentioned provide structural components that keep the desiccant away from the food and allow for easy retrieval of the desiccant pack.

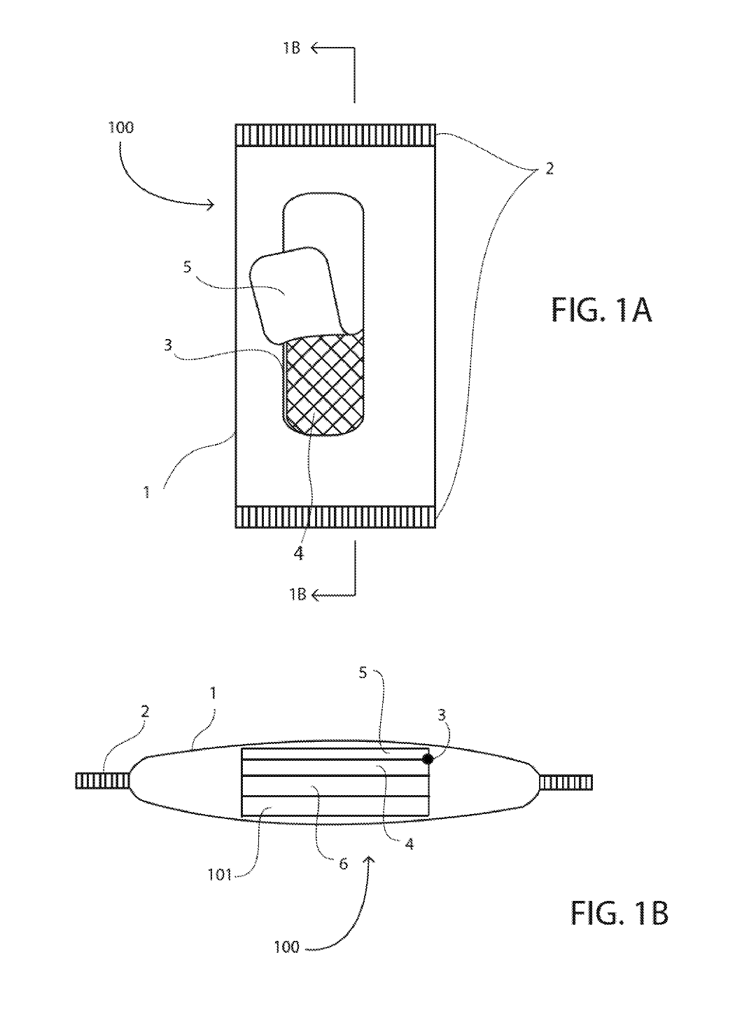

FIGS. 1A and 1B show an example embodiment of a desiccant device, or pod. The following reference numbers are associated with the corresponding aspects of the example.

1 Moisture proof packaging material

2 Packaging Heat seal

3 Frangible seal (Seal is secure until peeling takes place to expose membrane.)

4 Membrane (keeps desiccant from touching food product, yet allows moisture to cross this barrier to pull humidity from food product bag or container.)

5 Removable strip—(Exposes water vapor permeable membrane to environment.)

6 Molecular sieve desiccant of amorphous Sodium Aluminosilicate

101 Magnetic material

The moisture proof package (1) is of a material that prevents water vapor from being moved through the material. This protects the desiccant e.g. molecular sieve (6) from being exposed to humidity. Each end of the package (2) has been heat sealed to further contain the desiccant. The removable strip (5) is also made of moisture barrier material and is connected to the device by way of a frangible seal (3). The removable strip is pulled back and discarded before use. The membrane (4) is exposed upon removing the removable strip (5). The device is then placed inside a food product bag 104 that contains a food that is to be subjected to low humidity levels by way of the desiccant removing moisture from the bag, and eventually the food. For a desired result, the bag would be closed with a clip 103 or rolled down to prevent or reduce ambient moisture from entering the enclosure.

Those knowledgeable in the art are aware of numerous manufacturing processes for making this type of device. The removable strip and membrane may be already integrated into the form prior to heat sealing or may be integrated at some other time during manufacturing.

There are many variations of ways that a person might use the devices described above. A user could open his (recently left exposed to the environment) chips, cookies or other foods items and then place an activated (newly exposed low humidity environment air) device 100 in the bag 104. The exposed desiccant (6) would pull humidity out of the surrounding air that the food product is in and reestablish the crispness by lowering the water activity in the food product. This would happen over a few minutes or few hours depending upon the surrounding air, the desired degree and timing of the reduction in humidity, and the ability for the food product to expel its water vapor to the surrounding air and finally into the desiccant. The type, form factor, and quantity of the desiccant are preferably such that crispness can be restored for a half full bag of a 13.5-ounce bag of chips that have been left open for 12 hours in a 60% humidify environment in less than 8 eight hours, assuming a generally tight seal after insertion of the desiccant device. Specifically, molecular sieve desiccants are especially efficient at performing the above action because they lower the humidity quickly, allow for a lower relative humidity inside a closed space, and are more efficient than standard silica gel desiccants.

### Variations

If a food-safe desiccant is used, the membrane and structure for holding the desiccant device may be optional. Alternatively, it may be that the desiccant is contained in a more permanent membrane. It may be that the desiccant is contained inside of a membrane that is non-porous at low humidity and becomes porous, exposing the desiccant at high humidity to protect the food. It may be that the pod is contained in a non-porous membrane that can be punctured at time of use to allow moisture absorption to begin. It may be that the pod is re-usable including, but not limited to, microwaving the desiccant (either in the pod or outside of the pod) so that moisture is removed making it re-usable.

In some versions the desiccant pod is maneuverable within the bag. Embodiments allowing maneuverability can include magnetic material attached to the pod, which could then be maneuvered by a magnet outside of the packaging.

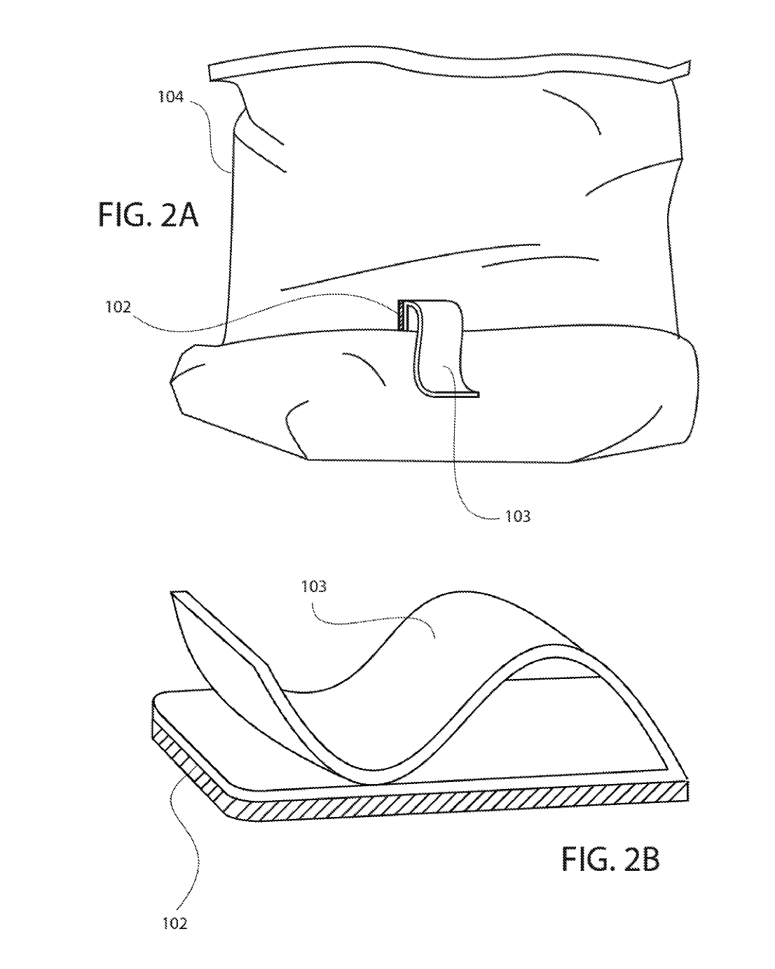

What is shown in the FIG. 2B is one possible embodiment of an external piece of a desiccant system. In FIG. 2A it is shown in use. In the version shown the external piece may serve as a clip 103 on the packaging 104 as well as a magnet 102 for retaining the internal pod in a desired location relative to the remaining food product.

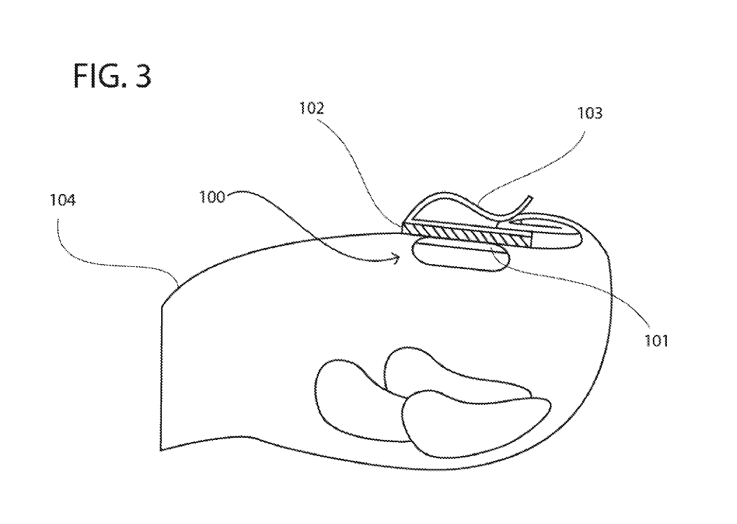

FIG. 3 is a schematic representation of a desiccant device 100 attached to a magnetic material 101 being held in place within a bag by an external magnet 102.

Other possible embodiments of the external piece could be a rod of plastic or metal; or a string of some material such as thread, or a flexible strip. There are many possibilities of embodiments of the external piece that help enable maneuverability of the pod.

The versions mentioned above with a string or rod can be thought of as a “tea bag” design. The pod would be at one end of a string or flexible rod, hanging within the bag at a desired height. The other end of the string or rod would extend out the package opening and be captured by the clip that holds the package closed. The string or rod could also be integrated into a clip.

Versions of the device may not have a maneuverability feature. They may be placed at a fixed point within the bag and held by an adhesive or may simply be inserted into the bag providing the composition or mechanical design of the pod prevents food from contacting any non-food safe substance.

It is claimed:

1. A method of restoring crispness to a food item by, in any operable order:
a) providing a device comprising a desiccant that has at least a portion of its surface covered by a moisture permeable, food-safe membrane, the membrane, in turn covered by a readily removable moisture barrier such that the desiccant does not absorb moisture until the cover is removed;
b) securing the device inside the original packaging of the food item;
c) removing the cover;
d) substantially resealing the food package.

2. A method of restoring crispness to a food item by, in any operable order:
a) providing a device comprising a food-safe desiccant covered by a readily removable moisture barrier such that the desiccant does not absorb moisture until the cover is removed;
b) securing the device inside the original packaging of the food item;
c) removing the cover;
d) substantially resealing the package.

3. The method of claim 2 where the food-safe desiccant is comprised of a molecular sieve of sodium aluminosilicate.

4. A desiccant system comprising:
a) a desiccant device of a desiccant material that is food-safe or, optionally is covered by a food-safe moisture permeable membrane, the desiccant material secured to a magnetic material;
b) a distinct mechanical device comprising a magnetic material of a size and shape suited to hold the desiccant device in place through a potato chip bag, where a least one of the magnetic materials comprises a magnet.

5. The system of claim 4 where the distinct mechanical device comprising a magnetic material is integrated with a clip suitable for holding a potato chip bag closed.
